(19) United States
(12) Patent Application Publication
(10) Pub. No.: US 2026/0310755 A1
(43) Pub. Date: Oct. 8, 2026

(54) BRAND MISAPPROPRIATION

(71) Applicant: ZEFR, Inc., Los Angeles, CA (US)

(72) Inventors: Or Levi, Zichron Yaakov (IL); Jonathan Morra, El Segundo, CA (US); Adi Levi, Zichron Yaakov (IL)

(21) Appl. No.: 19/446,531

(22) Filed: Jan. 12, 2026

Related U.S. Application Data
(60) Provisional application No. 63/784,814, filed on Apr. 7, 2025.

(51) Int. Cl. G06F 18/2415; G06N 3/0895; G06Q 30/0201

(52) U.S. Cl. CPC G06F 18/2415; G06N 3/0895; G06Q 30/02013

(57) ABSTRACT

For identifying brand misappropriation, a method trains a classification model to recognize protected brands, misrepresentation of a brand, and defamation of the brand. The method receives content and analyzes the content using the classification model. The method classifies the content based on at least one of brand criteria. The method identifies brand misappropriation based on the classification. The method mitigates the brand misappropriation.

### CROSS-REFERENCE TO RELATED APPLICATIONS

This application claims priority to U.S. Provisional Patent Application No. 63/784,814 entitled “BRAND MISAPPROPRIATION” and filed on Apr. 7, 2025 for Or Levi, which is incorporated herein by reference.

### BACKGROUND INFORMATION

The subject matter disclosed herein relates to brand misappropriation.

### BRIEF DESCRIPTION

A method identifies and/or mitigates brand misappropriation. The method trains a classification model to recognize protected brands, misrepresentation of a brand, and defamation of the brand. The method receives content and analyzes the content using the classification model. The method classifies the content based on at least one of brand criteria. The method identifies brand misappropriation based on the classification. The method mitigates the brand misappropriation. An apparatus and computer readable program product also perform the method.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of content system;

FIG. 2 is a schematic block diagram illustrating one embodiment of brand data;

FIGS. 3A-C are schematic diagrams illustrating one embodiment of content space;

FIG. 4A is a schematic block diagram illustrating one embodiment of a computer;

FIG. 4B is a schematic diagram illustrating one embodiment of a neural network;

FIG. 5A is a flow chart diagram illustrating one embodiment of a brand mitigation method;

FIG. 5B is a flow chart diagram illustrating one embodiment of a classification model training method; and

FIG. 5C is a flow chart diagram illustrating one alternate embodiment of a classification model training method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Go, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

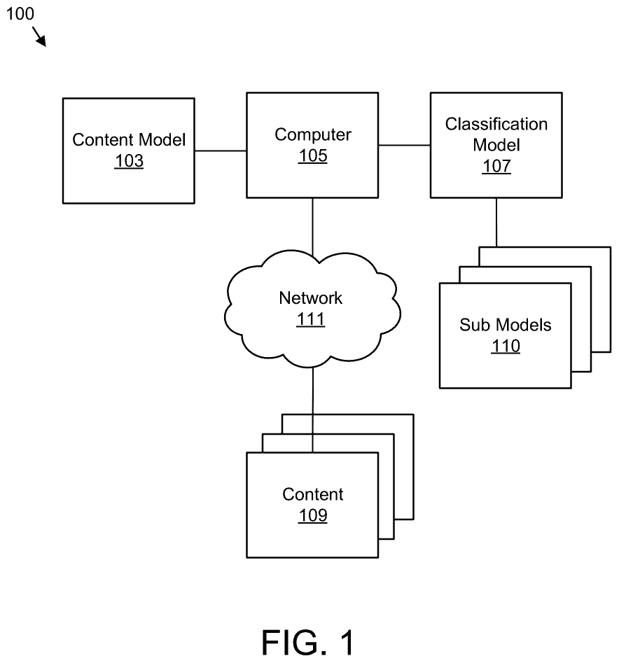

FIG. 1 is a schematic block diagram illustrating one embodiment of content system 100. In the depicted embodiment, content system 100 includes a classification model 107, a content model 103, sub models 110, a computer 105, a network 111, and content 109. The computer 105 may access the content 109 via the network 111. The network 111 may be the Internet, a mobile telephone network, a television network, a wide area network, a local area network, and the like.

In one embodiment, the computer 105 receives content 109 via the network 111. The computer 105 analyzes the content 109 using the classification model 107. The computer 105 may classify the content 109 using brand criteria. In one embodiment, the classification model 107 comprises a sub model 110 for each criterion of the brand criteria.

The computer 105 may use the classification model 107 to determine whether the content 109 features a protected brand. A protected brand may comprise at least one of a commercial brand and brand intellectual property. The computer 105 using the classification model 107 may further determine whether the content 109 misrepresents the protected brand. In addition, the computer 105 using the classification model 107 may determine whether the content 109 defames the protected brand.

In one embodiment, the classification model 107 comprises a content model 103. The content model 103 may be integrated with the classification model 107. Alternatively, the content model 103 may be in communication with the classification model 107. The content model 103 detects artificial intelligence (AI) generated content 109. The detection of AI generated content 109 is used to classify the content 109 and/or determine whether content 109 defames a protected brand.

The computer 105 may further identify brand misappropriation based on the classification. As used herein, brand misappropriation includes misrepresentation and/or defamation. Misrepresentation may comprise at least one of misrepresentation and manipulation. Defamation may include at least one of defamation and harm. In one embodiment, the computer mitigates the brand misappropriation.

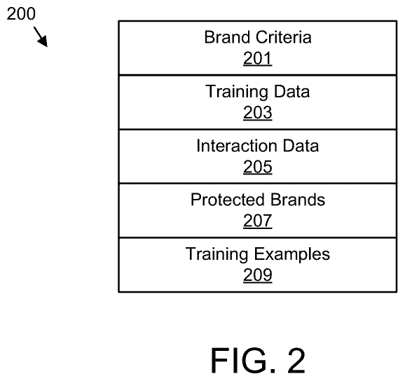

FIG. 2 is a schematic block diagram illustrating one embodiment of brand data 200. The brand data 200 may be organized as data structure in the memory. In the depicted embodiment, the brand data 200 includes brand criteria 201, training data 203, interaction data 205, the protected brands 207, and training examples 209.

The brand criteria 201 may include the criterion of whether the content 109 features a protected brand 207. In addition, the brand criteria 201 may include criterion of whether the content 109 misrepresents the protected brand 207. The brand criteria 201 may further include the criteria of whether the content 109 defames the protected brands 207. The classification model 107 may comprises a sub-model for each criterion of the brand criteria 201.

In one embodiment, the brand criteria 201 is satisfied if each criterion is satisfied. Alternatively, the brand criteria 201 is satisfied if at least two criteria are satisfied. In a certain embodiment, the brand criteria 201 is satisfied if at least one criterion is satisfied.

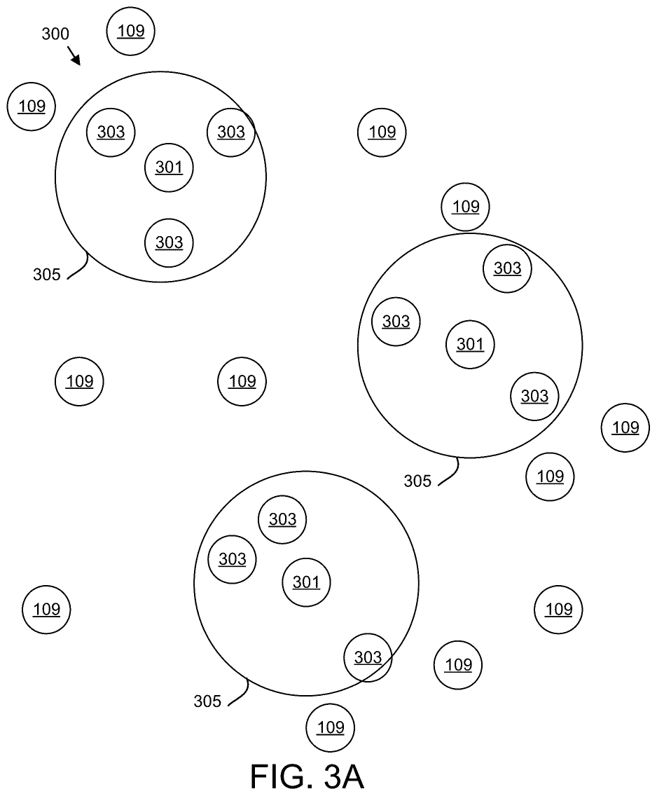

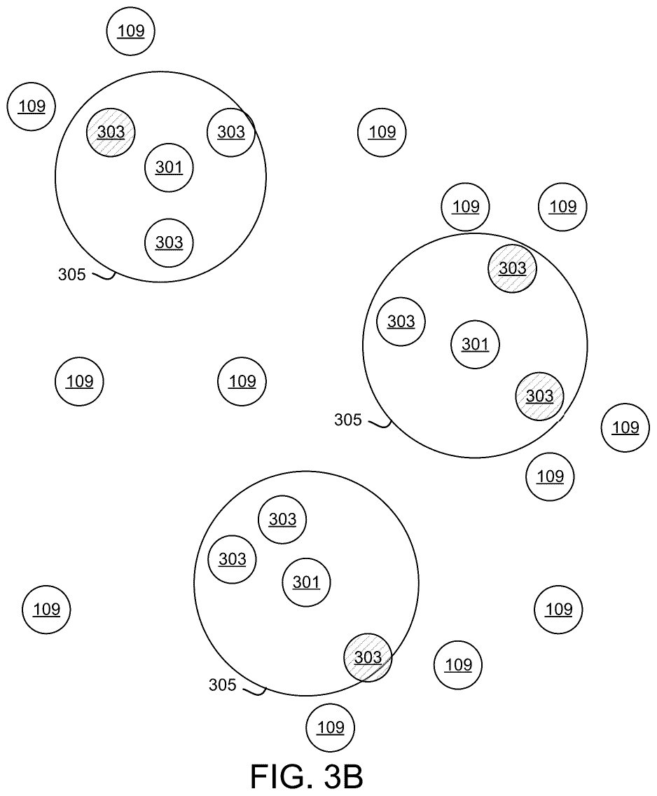

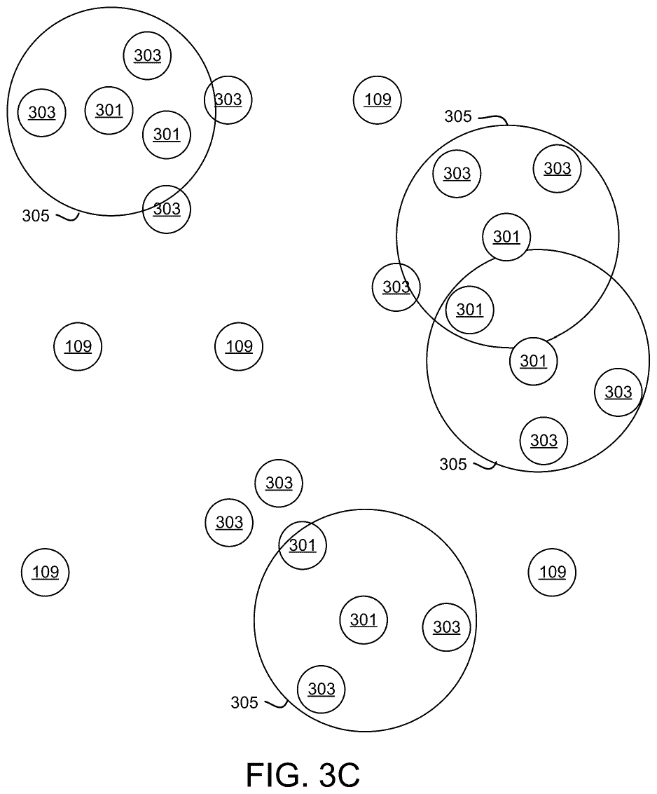

FIGS. 3A-C are schematic diagrams illustrating one embodiment of content space 300. The content space 300 may be a multi-feature space for a plurality of content features. Content features may comprise at least one of the elements of Table 1.

TABLE 1

Text
Product image
Images
Setting
Identifiable characters
Unidentifiable characters
Actions
AI generated

The content space 300 includes a plurality of content 109. Content 109 may be labeled as misappropriated content 301 or neighbor content 303. In a certain embodiment, the content 109 is labeled as AI generated content 109. In the depicted embodiment of FIG. 3A, three instances of misappropriated content 301 are identified from the content 109. The misappropriated content 301 may be used as seeds for training the classification model 107.

In addition, neighbor content 303 is identified for each of the misappropriated content 301. In one embodiment, neighbor content 303 is within a neighbor distance 305 of misappropriated content 301. The neighbor content 303 may be classified based on the brand criteria 201. If neighbor content 303 satisfies the brand criteria 201, the neighbor content 303 is identified as misappropriated content 301.

Referring now to FIG. 3B, four instances of neighbor content 303 are hashed, indicating that the neighbor content 303 satisfied the brand criteria 201. Referring to FIG. 3C, the neighbor content 303 satisfying the brand criteria 201 is identified as misappropriated content 301. In addition, additional content 109 is identified as neighbor content 303 of the newly identified misappropriated content 301. The new neighbor content 303 may be tested using the brand criteria 201. As a result, the content 109 may be classified using zero-shot and/or few-shots classification. The few shots classification may employ training examples 209. In one embodiment, many examples of misappropriated content 301 may be found from a large body of content 109 for use as training data 203 for training the classification model 107.

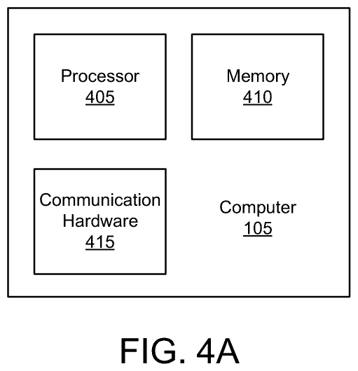

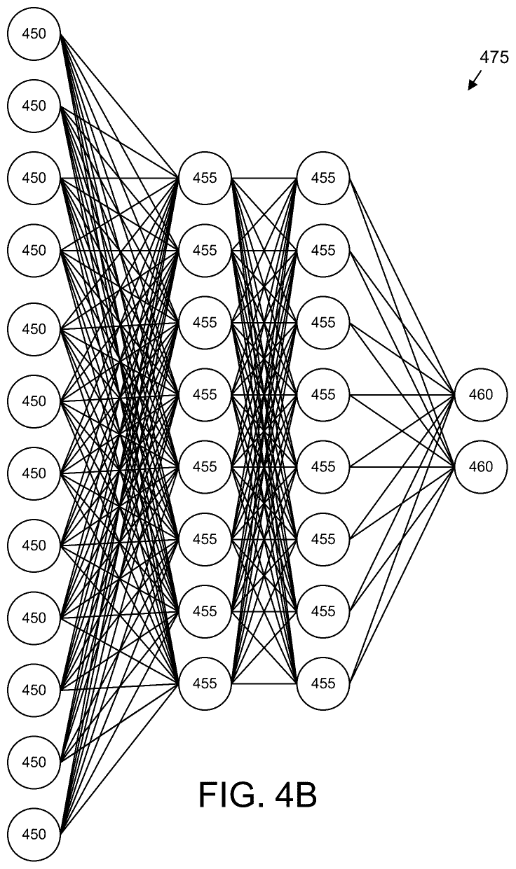

FIG. 4A is a schematic block diagram illustrating one embodiment of the computer 105. In the depicted embodiment, the computer 105 includes a processor 405, memory 410, and communication hardware 415. The memory 410 may store code and data. The processor 405 may execute the code and process the data. Communication hardware 415 may communicate with other devices.

In one embodiment, a plurality of processors 405 calculate neighbor distances 305 in parallel to accelerate operations. The plurality of processors 405 may share a memory 410 and coordinate operations via the memory 410.

FIG. 4B is a schematic drawing illustrating one embodiment of the neural network 475. In the depicted embodiment, the neural network 475 includes input neurons 450, hidden neurons 455, and output neurons 460. The neural network 475 may be organized as a large language model, convolutional neural network, a recurrent neural network, long short term memory (LSTM) network, a transformer, and the like.

The neural network 475 may be generated from the content 109 using zero-shot or few-shots inference. In addition, the neural network 475 may be trained with the training data 203. The neural network 475 may be trained using one or more learning functions while applying the training data to the input neurons 450 and known result values for the output neurons 460. Subsequently, the neural network 475 may receive actual data at the input neurons 450 and make predictions at the output neurons 460 based on the actual data. The actual data may include data from the content 109.

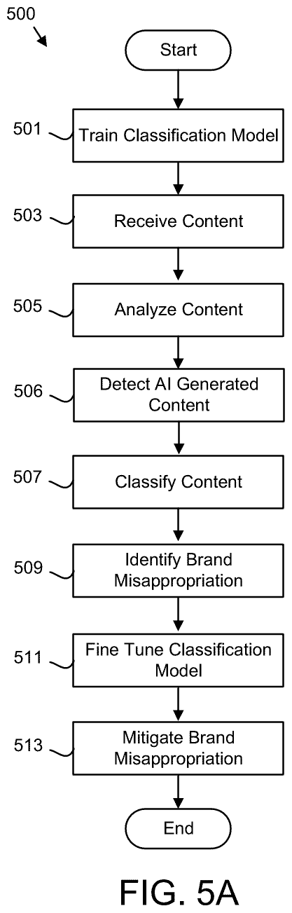

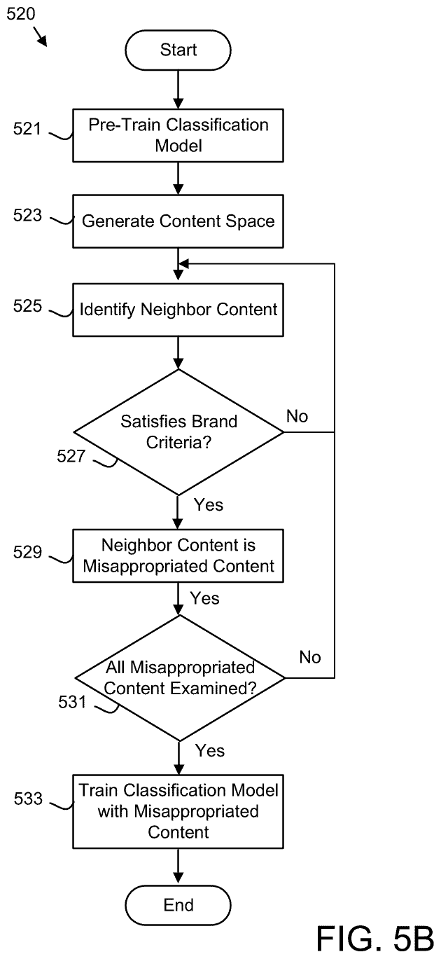

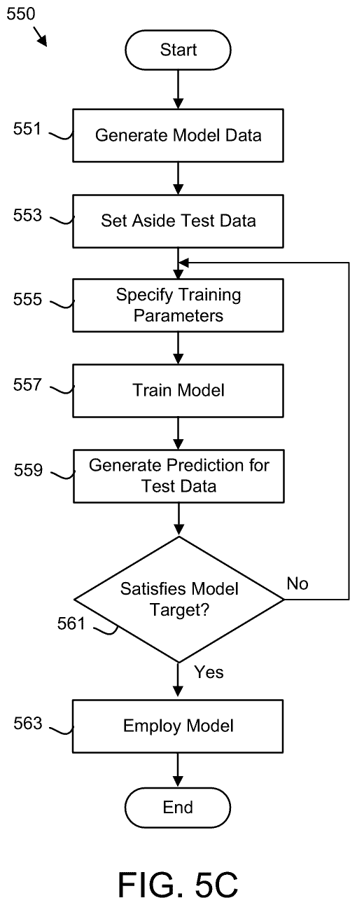

FIG. 5A is a flow chart diagram illustrating one embodiment of a brand mitigation method 500. The method 500 may classify content 109 based on the brand criteria 201 to identify brand misappropriation. In addition, the method 500 may mitigate brand misappropriation. The method 500 may be performed by the computer 105, the neural network 475, and/or classification model 107.

The method 500 may train 501 the classification model 107. Embodiments of training 501 the classification model 107 are described hereafter in FIGS. 5B and 5C.

The method 500 receives 503 content 109. The content 109 may be received by the computer 105 via the network 111.

The content 109 is analyzed 505 using the classification model 107. The classification model 107 may perform inference on a subset of content 109, using a search-based pre-screening of relevant candidates for misappropriated content 301.

The content model 103 may detect 506 AI generated content 109. In one embodiment, AI generated content 109 is detected 506 based on element proportions, color proportions, metadata, and the like.

The content 109 is further classified 507 based on at least one of the brand criteria 201. In addition, the content 109 may be classified 507 based on a detection of AI generated content 109. If the content 109 satisfies brand criteria 201, brand misappropriation is identified 509 as the classification. In one embodiment, the brand criteria 201 is modified in response to the content 109 being artificial intelligence (AI) generated.

In one embodiment, the method 500 fine tunes 511 the classification model 107 using the interaction data 205. The interaction data 205 may be recorded when the content 109 is viewed.

In one embodiment, the method 500 mitigates 513 the brand misappropriation. Mitigating the brand misappropriation comprises at least one of flagging the content 109, restricting the content 109, and removing the content 109.

FIG. 5B is a flow chart diagram illustrating one embodiment of a classification model training method 520. The method 520 may identify misappropriated content 301 in the classification model 107 using the content space 300 as shown in FIGS. 3A-C. In a certain embodiment, the method 520 identifies the misappropriated content 301 as training data 203 for training the classification model 107.

In one embodiment, the method 520 pre-trains 521 the classification model 107. The classification model 107 may be pre-trained 521 with training data 203 and/or training examples 209. The method 520 further generates 523 the content space 300.

The method 520 may identify 525 neighbor content 303 based on misappropriated content 301. In one embodiment, the neighbor content 303 is within a neighbor distance 305 of misappropriated content 301.

The method 520 determines 527 if the neighbor content 303 satisfies the brand criteria 201. The classification model 107 may be employed to determine 527 the neighbor content 303 satisfies the brand criteria 201. In response to the neighbor content 303 satisfying the brand criteria 201, the neighbor content 303 is identified as misappropriated content 301. If the neighbor content 303 does not satisfy the brand criteria 201, the method 520 loops to identify 525 neighbor content 303.

The method 520 determines 531 if all misappropriated content 301 and/or neighbor content 303 is examined. If all misappropriated content 301 and/or neighbor content 303 is not examined, the method 520 loops to identify 525 neighbor content 303.

If all the misappropriated content 301 and/or neighbor content 303 is examined, the content 109 has been examined and the misappropriated content 301 identified. The misappropriated content 301 may be mitigated 513 as described in FIG. 5A.

In one embodiment, if all misappropriated content 301 and/or neighbor content 303 is examined, the misappropriated content 301, the neighbor content 303, and/or content 109 becomes the training data 203. The classification model 107 may be trained 533 and/or fine-tuned using the misappropriated content 301, the neighbor content 303, and/or content 109.

FIG. 5C is a flow chart diagram illustrating one alternate embodiment of a classification model training method 550. The method 550 may train the classification model 107, the content model 103, and/or the sub models 110 using the training data 203. The method 550 may train the classification model 107, the content model 103, and/or the sub models 110 using supervised learning.

The method 550 starts and in one embodiment, the method 550 generates 551 the training data 203. The training data 203 may be historic data. In one embodiment, real-time model training data 203 is also used.

The method 550 may set aside 553 a portion of the training data 203 as test data. The test data will not be used to train the classification model 107, the content model 103, and/or the sub models 110.

The method 550 may specify 555 the training parameters. The classification model 107, the content model 103, and/or the sub models 110 are trained 557 using the training data 203 in accordance with the training parameters.

The method 550 generates 559 a prediction from the classification model 107, the content model 103, and/or the sub models 110 with the test data. The prediction may be the identification of brand misappropriation based on the classification. The method 550 determines 561 whether the prediction satisfies the target model. If the prediction does not satisfy the target model, the training parameters are modified 555 and the classification model 107 is again trained 557. If the prediction satisfies the target model, the trained classification model 107, the content model 103, and/or the sub models 110 is employed 563 and the method 550 ends.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
training a classification model to recognize protected brands, misrepresentation of a brand, and defamation of the brand;
receiving content;
analyzing the content using the classification model;
classifying the content based on at least one of the following brand criteria:
whether the content features a protected brand;
whether the content misrepresents the protected brand;
whether the content defames the protected brand;
identifying brand misappropriation based on the classification; and
mitigating the brand misappropriation.

2. The method of claim 1, wherein training the classification model comprises:
generating a content space for a plurality of content, wherein the content space is multi-feature space for a plurality of content features;
identifying neighbor content of a misappropriated content;
in response to the neighbor content satisfying the at least one brand criteria, identifying the neighbor content as misappropriated content; and
training the classification model using the misappropriated content.

3. The method of claim 2, wherein the content features comprise at least one of artificial intelligence (AI) generated, text, product image, an image, a setting, identifiable characters, unidentifiable characters, and an action.

4. The method of claim 1, wherein classifying the content is performed using zero-shot classification.

5. The method of claim 1, wherein classifying the content is performed using few-shot classification from training examples.

6. The method of claim 1, wherein the classification model is trained using supervised learning.

7. The method of claim 1, wherein mitigating the brand misappropriation comprises at least one of flagging the content, restricting the content, and removing the content.

8. The method of claim 1, wherein the classification model performs inference on a subset of content, using a search-based pre-screening of relevant candidates for misappropriated content.

9. The method of claim 1, the method further comprising fine-tuning the classification model using interaction data.

10. The method of claim 1, wherein the classification model comprises a content model for detecting artificial intelligence (AI) generated content and the detection is used to classify the content.

11. The method of claim 1, wherein the classification model comprises a sub-model for each criterion of the brand criteria.

12. The method of claim 1, wherein brand misappropriation is identified in response to each criterion being satisfied.

13. The method of claim 1, wherein the brand criteria is modified in response to the content being artificial intelligence (AI) generated.

14. An apparatus comprising:
a processor executing code to perform:
training a classification model to recognize protected brands, misrepresentation of a brand, and defamation of the brand;
receiving content;
analyzing the content using the classification model;
classifying the content based on at least one of the following brand criteria:
whether the content features a protected brand;
whether the content misrepresents the protected brand;
whether the content defames the protected brand;
identifying brand misappropriation based on the classification; and
mitigating the brand misappropriation.

15. The apparatus of claim 14, wherein training the classification model comprises:
generating a content space for a plurality of content, wherein the content space is multi-feature space for a plurality of content features;
identifying neighbor content of a misappropriated content;
in response to the neighbor content satisfying the at least one brand criteria, identifying the neighbor content as misappropriated content; and
training the classification model using the misappropriated content.

16. The apparatus of claim 15, wherein the content features comprise at least one of artificial intelligence (AI) generated, text, product image, an image, a setting, identifiable characters, unidentifiable characters, and an action.

17. The apparatus of claim 14, wherein classifying the content is performed using zero-shot classification.

18. The apparatus of claim 14, wherein classifying the content is performed using few-shot classification from training examples.

19. The apparatus of claim 14, wherein the classification model is trained using supervised learning.

20. A computer readable program product comprising a non-transitory computer medium storing code executed by a processor to perform:
training a classification model to recognize protected brands, misrepresentation of a brand, and defamation of the brand;
receiving content;
analyzing the content using the classification model;
classifying the content based on at least one of the following brand criteria:
whether the content features a protected brand;
whether the content misrepresents the protected brand;
whether the content defames the protected brand;
identifying brand misappropriation based on the classification; and
mitigating the brand misappropriation.
